(19) United States
(12) Patent Application Publication
(10) Pub. No.: US 2013/0286895 A1
(43) Pub. Date: Oct. 31, 2013

(54) Discovery and Configuration of Network Devices via Data Link Layer Communications

(71) Applicants: Balaji Mittapalli, Cedar Park, TX (US); Brian Gautreau, Round Rock, TX (US)

(72) Inventors: Balaji Mittapalli, Cedar Park, TX (US); Brian Gautreau, Round Rock, TX (US)

(73) Assignee: DELL PRODUCTS, LP, Round Rock, TX (US)

(21) Appl. No.: 13/460,492

(22) Filed: Apr. 30, 2012

(51) Int. Cl. H04L 12/28

(52) U.S. Cl. 370/255

(57) ABSTRACT

A method includes discovering a network device that has connected to a data link layer of a network based on a discovery packet broadcast by the network device via the data link layer. The method further includes configuring the network device based on a response packet transmitted to the network device via the data link layer in response to discovering the network device.

### FIELD OF THE DISCLOSURE

This disclosure relates generally information handling systems, and relates more particularly to discovery and configuration of network devices in information handling systems.

BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software resources that may be configured to process, store, and communicate information and may include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements.

Embodiments incorporating teachings of the present disclosure are shown and described with respect to the drawings presented herein, in which:

FIG. 1 is a functional block diagram illustrating a network implementing a network device discovery and configuration process in accordance with at least one embodiment of the present disclosure;

FIG. 2 is a functional block diagram illustrating an network device in accordance with at least one embodiment of the present disclosure;

FIG. 3 is a flow diagram illustrating a method of discovering and configuring a network device having joined a network in accordance with at least one embodiment of the present disclosure;

FIG. 4 is a block diagram illustrating an example management-type packet format in accordance with at least one embodiment of the present disclosure;

FIG. 5 is a diagram illustrating an example packet exchange between a management console and a joining network device in accordance with at least one embodiment of the present disclosure; and

FIG. 6 is a diagram illustrating another example packet exchange between a management console and a joining network device in accordance with at least one embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

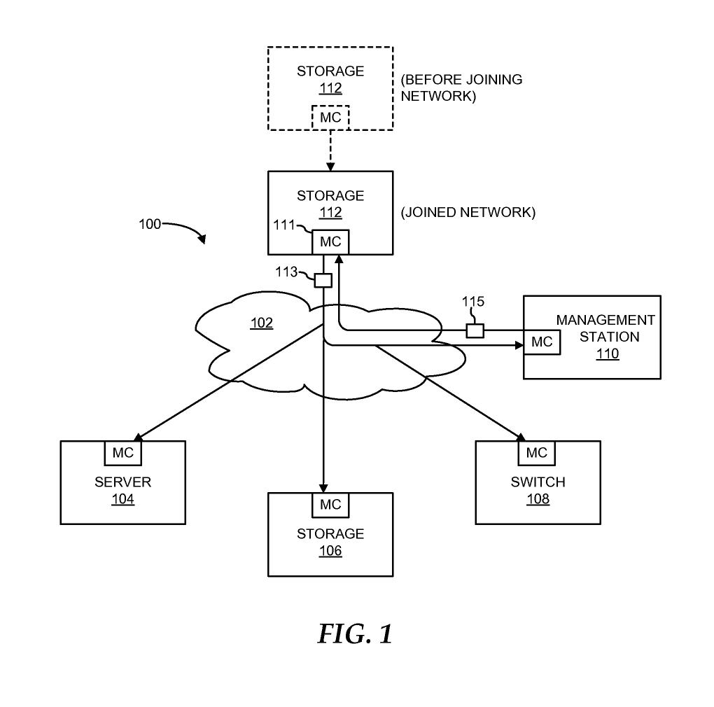

FIGS. 1-6 illustrate example techniques for auto-discovery and configuration of network devices via an Ethernet network or other data link layer network. A network device, upon joining or otherwise connecting to the network, broadcasts a discovery packet on at the data link layer of the network. A management station on the network receives the discovery packet and identifies the discovery packet as a management-type packet using a filter that searches for a specified value in a specified field, such as in the Ethertype field of an Ethernet packet. If a predefined configuration is available for the joining network device (such as a predefined configuration based on the type of device), the management station can respond to the joining network device with one or more unicast response packets containing configuration information representative of the available configuration. If a predefined configuration is not available, a user can subsequently interface with the management station or another device on the network to specify a configuration for the joining network device, and the management station then can unicast one or more response packets containing configuration information to the joining network device. This approach enables auto-discovery and configuration without relying on higher-level network services such as Domain Name Service (DNS) and Dynamic Host Configuration Protocol (DHCP), which may not be available in the network or may require multiple-administrator intervention (such as when the administrator for DNS and the administrator for DHCP are not the same administrator). Moreover, this approach enables the auto-discovery of switches and network storage in addition to servers. In contrast, conventional auto-discovery techniques typically are limited to only servers as switches and network storage require physical presence for the initial configuration of IP address, username, and password under the conventional auto-discovery techniques.

Although any of a variety of data link layer networks (that is, Open Systems Interconnect (OSI) layer 2 networks) may be advantageously used in accordance with the teachings provided herein, for ease of illustration the techniques of the present disclosure are more particularly described in a non-limiting example implementation of the data link layer network as an Ethernet network (as substantially conforming to one or more standards of the IEEE 802.3 family of standards).

FIG. 1 illustrates a network 100 that facilitates auto-discovery and configuration of network devices in accordance with at least one embodiment of the present disclosure. The network 100 comprises a local area network (LAN) including a plurality of network devices coupled via an Ethernet network 102 (or other data link layer network). For purposes of this disclosure, a network device comprises an information handling system that includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, a network device can include a server or server blade, a storage device, a switch, a router, a wireless router, a personal computer, a personal data assistant, a consumer electronic device (such as a portable music player, a portable DVD player, or a digital video recorder), or any other suitable device, and can vary in size, shape, performance, functionality, and price. A network device can also include a set of any of the foregoing devices.

Two or more network devices can be coupled together via the Ethernet network 102 such that network devices in the network, referred to as nodes of the network, can exchange information with each other. The nodes on a network can include storage devices, file servers, print servers, personal computers, laptop computers, personal data assistants, media content players, other devices capable of being coupled to a network, or any combination thereof. To illustrate, FIG. 1 depicts an example configuration whereby the network devices include a server 104, a network attached storage (NAS) device 106, a network switch 108, and a management station 110.

During typical steady-state operation, the network devices communicate via the transmission of packets via the network 100. The transmission of these packets typically includes formatting and encapsulation in accordance with higher-level network protocols (that is, OSI layer 3 and higher), such as in accordance with the Telecommunications Protocol/Internet Protocol (TCP/IP), User Datagram Protocol (UDP), DNS and DHCP, among others. At these higher levels, a packet is appended with a source IP address and a destination IP address. At the data link layer (OSI layer 2), each packet is further appended with physical address information, such as the source media access control (MAC) address and the destination MAC address, and other control information, and the packet is then provided to the physical layer (PHY) interface of the networked device for physical transmission to the receiving network device. The receiving network device deencapsulates the packet in the reverse of the process in which it was encapsulated.

In order to achieve in this typical steady-state operation, the network devices generally require a higher degree of network configuration, such as the configuration of an IP address for the network device, configuration of login or authentication credentials (such as user name and password), firmware updates, and the like. Such configuration conventionally is achieved either by manual configuration of the network device before the network device is connected to the network 100 or through the discovery and remote configuration of a network device using techniques based on layer-3 or higher protocols, such as DNS or DHCP. In contrast, the network 100 provides auto-discovery and configuration of a network device that has joined or otherwise connected to the network 100 (referred to herein as the “joining network device”) based on broadcast of a discovery packet from the joining network device and subsequent response packets conducted in a manner that makes use of network protocols only at the data link layer and lower.

To illustrate, upon connecting to the Ethernet network 102 of network 100, a management controller (MC) 111 of a joining network device 112 (illustrated in FIG. 1 as a storage device) automatically broadcasts a discovery packet 113 via the Ethernet network 102 to the network devices 104-110. Each of the networked devices 104-110, in turn, receives the discovery packet 113 at the corresponding device's MC and filters the discovery packet based on a predefined filter criterion, described in greater detail below. In response to identifying the discovery packet 113 as being of a management-type packet based on the filtering, the management station 110 responds to the discovery-related commands in the payload of the discovery packet 113 by adding the joining network device 112 to a table or other data structure identifying the network devices currently on the network 100 (if the joining network device 112 is not already represented in the table). The management station 100 also responds with one or more response packets 115 unicast to the joining network device 112 using information obtained from the discovery packet. The one or more response packets can include an acknowledgment packet acknowledging the discovery packet, a packet requesting further information from the joining network device 112, a configuration packet providing configuration information for the joining network device, or a combination thereof. The configuration information can include, for example, an IP address or other addressing information for the joining network device 112, a firmware update, login credential information, and the like.

As the auto-discovery and configuration communications are limited to the data link layer in the above-described embodiment, routers cannot be used to route a management-type packet across disparate networks. Rather, the management-type packets generally are limited to traveling within a local Ethernet network, such as a set of network devices in the same broadcast domain or in the same virtual local area network (VLAN). However, if a wider routing of the management-type packets is desired, the routers of the network can implement a relay to relay management-type packets between disparate networks in a manner similar to the DHCP relay process.

By initiating the auto-discovery process at the joining network device 112 and conducting the packet exchange for the auto-discovery and subsequent configuration at the data link layer, the use of higher-level network protocols can be avoided during the auto-discover and configuration phase. This enables auto-discovery and configuration of joining network devices in which these higher-level network protocols may be unavailable or would otherwise require customization or complex synchronization between these higher-level protocols.

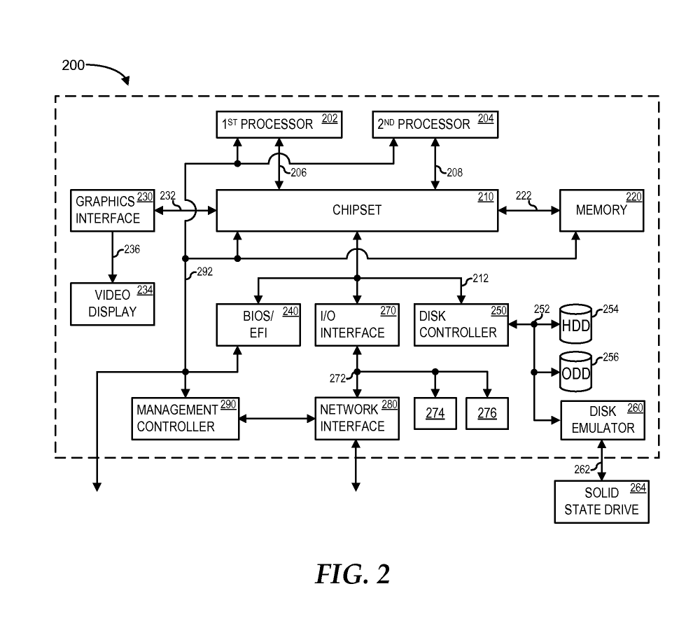

FIG. 2 shows a network device 200 that is representative of the general configuration of the network devices 104-112 of the network 100 of FIG. 1. The network device 200 can include a processor 202 coupled to a chipset 210 via a host bus 206, and can further include one or more additional processors, generally designated as an n^{th} processor 204 coupled to the chipset 210 via a host bus 208. The chipset 210 can support processors 202 through 204, allowing for simultaneous processing by processors 202 through 204, and can support the exchange of information within the network device 200 during multiple processing operations. As illustrated, the chipset 210 functions to provide access to the processor 202 via the host bus 206, and n^{th} processor 204 via the host bus 208. In another embodiment (not illustrated), chipset 210 can include a dedicated bus to transfer data between processors 202 and 204. In accordance with yet another aspect, the chipset 210 can be generally considered an application specific chipset that provides connectivity to various buses, and integrates other system functions. As such, the chipset 210 can be provided using a chipset that includes two or more parts. For example, the chipset 210 can include a Graphics and Memory Controller Hub (GMCH) and an I/O Controller Hub (ICH), or can include a Northbridge and a Southbridge.

The network device 200 can include a memory 220 coupled to the chipset 210 via a memory bus 222. As illustrated, the chipset 210 can be referred to as a memory controller, where the chipset 210 is coupled to host buses 206 through 208, and the memory bus 222 as individual buses. The chipset 210 can also provide bus control and can handle transfers between the processors 202 and 204 and memory 220. A non-limiting example of memory 220 includes static, dynamic or non-volatile random access memory (SRAM, DRAM, or NVRAM), read only memory (ROM), flash memory, another type of memory, or any combination thereof.

The network device 200 can also include a graphics interface 230 that can be coupled to the chipset 210 via a graphics bus 232. The graphics interface 230 can provide a video display output 236 to a video display 234. The video display 234 can include one or more types of video displays, such as a flat panel display or other type of display device. The network device 200 can also include a basic input and output system/extensible firmware interface (BIOS/EFI) module 240 coupled to the chipset 210 via an I/O channel 212. The BIOS/EFI module 240 can include BIOS/EFI code operable to detect and identify resources within network device 200, provide the appropriate drivers for those resources, initialize those resources, and access those resources. The I/O channel 212 can include a Peripheral Component Interconnect (PCI) bus, a PCI-Extended (PCI-X) bus, a high-speed link of PCI-Express (PCIe) lanes, another industry standard or proprietary bus or link, or any combination thereof. The chipset 210 can include other buses in association with, or independent of, I/O channel 212, including other industry standard buses (e.g., Industry Standard Architecture (ISA), Small Computer Serial Interface (SCSI), Inter-Integrated Circuit (I²C), System Packet Interface (SPI), or Universal Serial Bus (USB), proprietary buses or any combination thereof.

The network device 200 can also include a disk controller 250 coupled to chipset 210 via the I/O channel 212. The disk controller 250 can include a disk interface 252 that can include other industry standard buses (e.g., Integrated Drive Electronics (IDE), Parallel Advanced Technology Attachment (PATA), Serial Advanced Technology Attachment (SATA), SCSI, or USB or proprietary buses, or any combination thereof. The disk controller 250 can be coupled to one or more disk drives via disk interface 252. Such disk drives include a hard disk drive (HDD) 254 or an optical disk drive (ODD) 256 (e.g., a Read/Write Compact Disk (R/W-CD), a Read/Write Digital Video Disk (R/W-DVD), a Read/Write mini Digital Video Disk (R/W mini-DVD), or another type of optical disk drive), or any combination thereof. Additionally, the network device 200 can include a disk emulator 260 that is coupled to the disk interface 252 via the disk interface 252. The disk emulator 260 can permit a solid-state drive 264 to be coupled to network device 200 via an external interface 262. The external interface 262 can include other industry standard busses (e.g., USB or IEEE 2394 (Firewire)) or proprietary busses, or any combination thereof. Alternatively, solid-state drive 264 can be disposed within the network device 200. The network device 200 can also include an I/O interface 270 coupled to the chipset 210 via the I/O channel 212. The I/O interface 270 can be coupled to a peripheral channel 272 that can be of the same industry standard or proprietary bus or link architecture as the I/O channel 212, or of a different industry standard or proprietary bus or link architecture than the I/O channel 212

The network device 200 can also include a network interface 280 that is coupled to the I/O interface 270 via the peripheral channel 272. Network interface 280 may be a network interface card (NIC) disposed within network device 200, on a main circuit board (e.g., a baseboard, a motherboard, or any combination thereof), integrated onto another component such as the chipset 210, in another suitable location, or any combination thereof. The network interface 280 provides an interface between components of the network device 200 and a network, such as network 100 of FIG. 1. The network interface 208 can include, for example, an Ethernet interface.

The network device 200 can further include a management controller (MC) 290 (see, for example, the MC 111 of FIG. 1) that can be coupled to the processors 202 and 204, the chipset 210, the memory 220, and the BIOS/EFI module 240 via a system communication bus 292. The MC 290 may be coupled to a network via the network interface 280. Alternatively, the MC 290 may be coupled to the network via a separate network interface coupled to the MC 290. The MC 290 may be on a main circuit board (e.g., a baseboard, a motherboard, or any combination thereof), integrated onto another component such as the chipset 210, in another suitable location, or any combination thereof. Other resources, such as the graphics interface 230, the video display 234, the I/O interface 270, the disk controller 250, the network interface 280, or any combination thereof, can be coupled to the MC 290. The system communication bus 292 can also provide an interface between the MC 290 and devices that are external to the network device 200. For example, the MC 290 can be coupled via the system communication bus 292 to the management station 112 of FIG. 1 for out-of-band management of network device 200. The MC 290 can be on a separate power plane in network device 200, so that the MC 290 can be operated while other portions of the network device 200 are powered off. The MC 290 may also be operated in a pre-operating-system operating state (e.g. during boot of the network device 200). Commands, communications, or other signals may be sent to or received from the MC 290 by any one or any combination of resources previously described. The MC 290 can be part of an integrated circuit or a chip set within the network device 200. A non-limiting example of a MC 290 includes a baseboard management controller (BMC), an integrated Dell remote access controller (iDRAC), another controller, or any combination thereof. A non-limiting example of a system communication bus 292 includes an inter-integrated circuit (I²C) bus, a system management bus (SMBus), a serial peripheral interface (SPI) bus, another bus, or any combination thereof.

The components and functionality of the network device 200, as described herein, can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The device can include software, including firmware embedded at a device or software capable of operating a relevant environment of the network device 200. The device or module can also include a combination of the foregoing examples of hardware or software. Note that a network device can include an integrated circuit or a board-level product having portions thereof that can also be any combination of hardware and software.

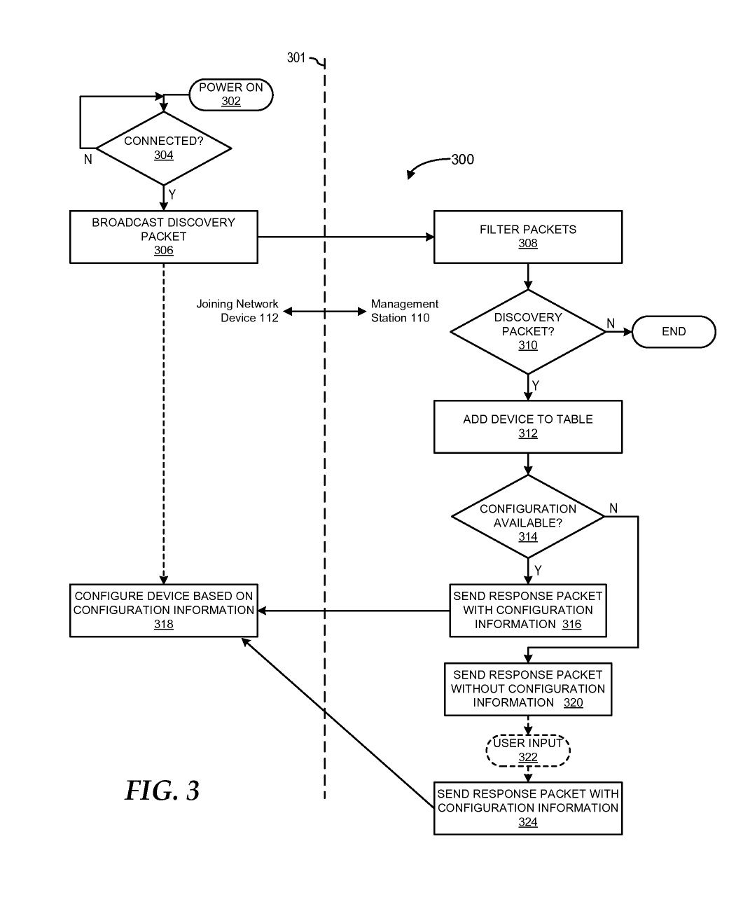

FIG. 3 illustrates a method 300 of auto-discovery and configuration of a joining network device via a data link layer of a network in accordance with at least one embodiment of the present disclosure. For ease of reference, the method 300 is described in the context of the network 100 of FIG. 1 and the network device 200 of FIG. 2. In the following description, operations represented by blocks to the left of line 301 are performed by the joining network device 112 and the operations represented by blocks to the right of line 301 are performed by the management station 110.

At block 302, the joining network device 112 is powered on and begins power-up initiation. As part of this initiation process, the MC 111 (see also MC 290 of FIG. 2) of the joining network device 112 monitors the connection status of the network interface 280 (FIG. 2) at block 304. In response to determining that the network interface 280 has established a connection to the Ethernet network 102, at block 306 the MC 111 generates the discovery packet 113 (FIG. 1) having a broadcast MAC address as the destination MAC address and the MAC address of the joining network device 112 as the source MAC address. The MC 111 also forms the discovery packet 113 so as to have a specified value in a specified field so as to facilitate identification of the discovery packet as a management-type packet, and to have one or more encoded commands in a payload field that instructs a receiving management station to process the joining network device 112 as a new network device on the Ethernet network 102. The MC 111 then broadcasts the discovery packet 113 to the other network devices 104, 106, 108, and 110 via the Ethernet network 102.

At block 308, the MC 290 of the management station 110 filters received packets based on the specified field. In response to receiving the discovery packet 113 and identifying the discovery packet 113 as being a management-type packet based on the specified value in the specified field at block 310 and in response to processing the one or more encoded commands in the payload, the management station 110 identifies the joining network device 112 as having joined the network 100 and thus at block 312 adds an identifier associated with the joining network device 112 (for example, the MAC address or service tag of the joining network device 112) to a table of the current network devices of network 100, unless the joining network device 112 is already represented in the table.

At block 314, the management station 110 determines whether a predefined configuration is available for the joining network device 112. The predefined configuration may be identified by, for example, a device type, service tag, or other classification of the joining network device 112 as identified by the joining network device 112 in the discovery packet 113 or a subsequent packet from the joining network device 112. Alternatively, the predefined configuration may have been previously configured at the management station 110 by a user specifically for the joining network device 112. In either event, if a predefined configuration is available, at block 316 the management station 110 transmits to the joining network 112 a response packet (for example, response packet 115 of FIG. 1) that contains configuration information for the predefined configuration in the payload field of the response packet. The configuration information can include, but is not limited to, IP address or higher-level address information for the joining network device 112, firmware update information, login credential/authentication information, and the like. If necessary, multiple response packets may be transmitted by the management station to convey the configuration information at block 316.

In response to receiving the one or more response packets with configuration information, at block 318 the joining network device 112 extracts the configuration information from the response packets and implements the configuration represented by the extracted configuration information. As the configuration typically includes higher-level addressing information and login/authentication information, the joining network device 112 typically is enabled to initiate higher-level communications via the network 100 after being so configured.

In the event that a predefined configuration is not available, at block 320 the management station 110 transmits to the joining network device 112 a response packet indicating that a configuration is not available for the joining network device 112. In response, the joining network device 112 enters a standby mode to await a configuration. At some later time, at block 322 an administrator or other user may interface with the management station 110 or other management component of the network 100 and set a configuration for the joining network device 112. To illustrate, an administrator may login to the management station 110 on a periodic basis to batch configure network devices newly joined since the last login. Once the user has set a configuration for the joining network device 112, at block 324 the management console 110 transmits to the joining network device 112 one or more response packets that contain configuration information for the user-specified configuration in the payload field of the one or more response packets. The joining network device 112 then may implement the specified configuration as described above with reference to block 318.

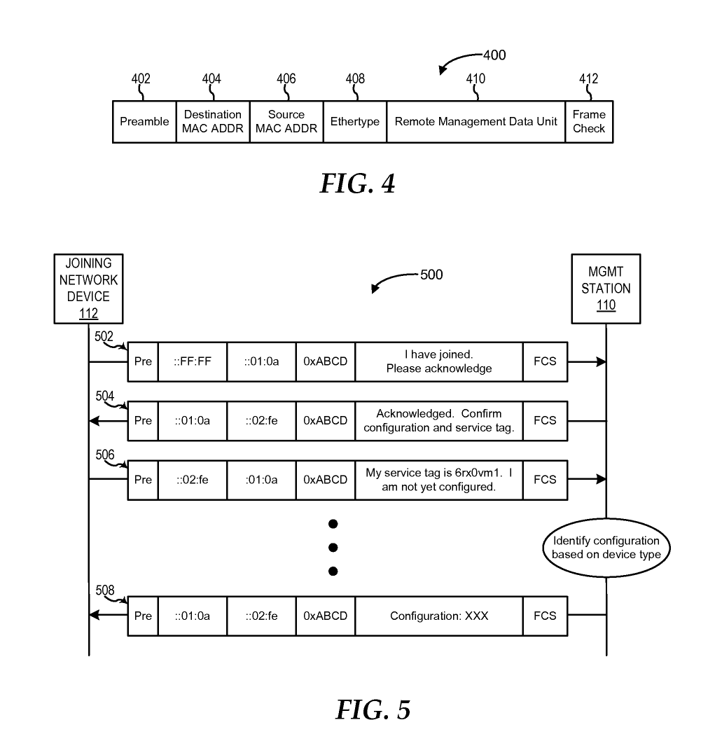

FIG. 4 illustrates an example packet format 400 for the management-type packets. In one embodiment, the management-type packets communicated between the joining network device and the other network devices (including a management station) are formatted as Ethernet packets (also called Ethernet “frames”) substantially in accordance with the IEEE 802 Ethernet family of specifications. As consistent with these specifications, the packet format 400 includes a preamble field 402, a destination MAC address field 404, a source MAC address field 406, an Ethertype field 408, a remote management data unit field 410 (referred to herein as the payload field 410), and a frame check sum field 412. Typically, the Ethertype field 408 includes a two-octet value that indicates which protocol is encapsulated in the payload field 410. In one embodiment, the Ethertype field 408 is used to store the specific value used to identify the packet as being a management-type packet. For example, a vendor or other provider of network components may petition the IEEE Registration Authority for assignment of a unique Ethertype value and thereafter configure the network components of the provider to use this assigned Ethertype value in the Ethertype field 408 when performing the auto-discovery and configuration process so that to facilitate identification of discovery and response packets as management-type packets. The payload field 410 contains header information and data corresponding to commands, control information, configuration information, and the like. In at least one embodiment, the payload field 410 is encoded to prevent unauthorized access to, or tampering with, the content of the payload field 410.

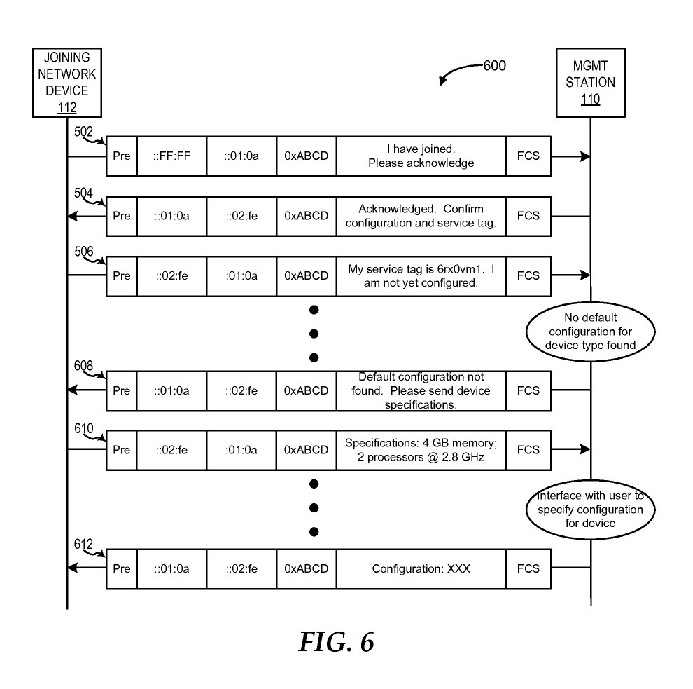

FIGS. 5 and 6 illustrate example exchanges of management-type packets between the joining network device 112 and the management station 110 of network 100 (FIG. 1) in the context of method 300. The management-type packets in these exchanges implement the packet format of FIG. 4. In the exchange 500 of FIG. 5, a predefined configuration is available at the time of discovery of the joining network device 112. In the exchange of FIG. 6, a predefined configuration is not available at the time of discover and thus a configuration is specified for the joining network 112 subsequent to its discovery. In each instance, the packets include a specific value of 0xABCD in the Ethertype field 408 so as to identify the packet as a management-type packet.

In the exchange 500 of FIG. 5, the joining network device 112 generates and transmits a discovery packet 502 in response to connecting to the network 100. The discovery packet 502 includes the broadcast MAC address ::FF:FF as the destination MAC address and the MAC address ::01:0a of the joining network device 112 as the source MAC address. The payload field 410 includes encoded data representing a message from the joining network device 112 that it has joined the network 100.

In response to the discovery packet 502, the management station 110 transmits a response packet 504 with a payload field 510 containing an acknowledgement and a command for the joining network device 112 to confirm whether it is already configured and to provide its service tag. In response to the response packet 504, the joining network device 112 generates and transmits to the management station 110 a response packet 506 with a payload field 410 containing the service tag of the joining network device 112 and a confirmation that the joining network device 112 is not yet configured. In response, the management station 110 identifies the predefined configuration for the joining network device 112 (based on, for example, the device type or service tag). The management station 110 then generates and transmits to the joining network device 112 one or more response packets 508 with a payload field 410 containing configuration information representative of the predefined configuration for the joining network device 112.

The exchange 600 of FIG. 6 initiates in the same manner as the exchange 500 in that the discovery packet 502 and response packets 504 and 506 are communicated between the joining network device 112 and the management station 110. However, in this example a predefined configuration is not available for the joining network device 112. Accordingly, the management station 110 generates and transmits to the joining network device 112 a response packet 608 with a payload field 410 containing an indicator that a predefined configuration is not available and a command for the joining network device 112 to send its specifications. In response, the joining network device 112 generates and transmits to the management station 110 a response packet 610 with a payload field 410 containing data representative of specifications of the joining network device 112.

At a subsequent time, a user interfaces with the management station 110 to specify a configuration for the joining network device 112. In response, the management station 110 generates and transmits to the joining network device 112 one or more response packets 612 with a payload field 410 containing configuration information representative of the user-specified configuration for the joining network device 112.

Note that not all of the activities described above in the general description or the examples are required, that a portion of a specific activity may not be required, and that one or more further activities may be performed, in addition to those described. Still further, the order in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features described herein in the context of separate embodiments for the sake of clarity, may also be provided in combination in a single embodiment. Conversely, various features that are, for brevity, described in the context of a single embodiment, may also be provided separately, or in any sub-combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur, or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
discovering a network device that has connected to a data link layer of a network based on a discovery packet broadcast by the network device via the data link layer; and
configuring the network device based on a response packet transmitted to the network device via the data link layer in response to discovering the network device.

2. The method of claim 1, wherein:
discovering the network device comprises:
the network device broadcasting the discovery packet responsive to connecting to the data link layer, the discovery packet having a broadcast media access control (MAC) address as a destination MAC address, a MAC address of the network device as a source MAC address, and a specified value in a specified field to identify the discovery packet as a management-type packet; and
a management console identifying the network device as having connected to the data link layer responsive to receiving the discovery packet and determining the discovery packet has the specified value in the specified field.

3. The method of claim 2, further comprising:
the management console transmitting the response packet to the network device in response to the discovery packet.

4. The method of claim 1, wherein:
configuring the network device comprises the management console determining configuration information for the network device and transmitting the first response packet having the MAC address of the network device as a destination MAC address and having configuration information in a data payload.

5. The method of claim 4, wherein:
the network device includes information identifying a device type of the network device in the discovery packet; and
the management console determines the configuration information for the network device based on the device type identified by the discovery packet.

6. The method of claim 4, further comprising:
a user interfacing with the management console to specify the configuration information for the network device subsequent to the network device transmitting the discovery packet; and
wherein configuring the network device comprises the management console transmitting the response packet with the configuration information responsive to the user interfacing with the management console.

7. The method of claim 2, wherein:
the data link layer comprises an Ethernet network;
the discovery packet and the response packet comprise Ethernet packets; and
the specified field comprises an Ethertype field.

8. The method of claim 2, wherein the network device broadcasting the discovery packet comprises the network device broadcasting the discovery packet after powering up and responsive to establishing a connection to the data link layer.

9. The method of claim 1, wherein the configuration information includes at least one of:
an Internet Protocol (IP) address for the network device; a login credential; an authentication configuration; and a firmware update.

10. The method of claim 1, wherein:
the data link layer comprises an Ethernet network; and
the discovery packet and the response packet comprise Ethernet packets.

11. An information handling system comprising:
a network interface to connect to a network; and
a management controller coupled to the network interface, the management controller to broadcast a discovery packet via a data link layer of the network responsive to establishing a connection to the data link layer of the network via the network interface, and to configure the information handling system based on configuration information contained in a response packet received via the data link layer.

12. The information handling system of claim 11, wherein:
the management controller is to configure the discovery packet to have a broadcast media access control (MAC) address as a destination MAC address, a MAC address of the information handling system as a source MAC address, and a specified value in a specified field to identify the discovery packet as a management-type packet.

13. The information handling system of claim 12, wherein:
the data link layer comprises an Ethernet network;
the discovery packet and the response packet comprise Ethernet packets; and
the specified field comprises an Ether type field.

14. The information handling system of claim 11, wherein the configuration information includes at least one of: an Internet Protocol (IP) address for the information handling system; a login credential; an authentication configuration; and a firmware update.

15. An information handling system comprising:
a network interface to connect to a network; and
a management controller coupled to the network interface, the management controller to identify a network device as having joined a data link layer of the network responsive to receiving a discovery packet broadcast by the network device via the data link layer, and to transmit to the network device via the data link layer a response packet comprising configuration information for the network device responsive to identifying the network device as having joined the data link layer.

16. The information handling system of claim 15, wherein the management controller identifies the network device as having joined the data link layer responsive to determining the discovery packet is a management-type packet in response to the discovery packet having a predetermined value in a predetermined field.

17. The information handling system of claim 16, wherein:
the data link layer comprises an Ethernet network;
the discovery packet and the response packet comprise Ethernet packets; and
the specified field comprises an Ether type field.

18. The information handling system of claim 15, wherein:
the discovery packet includes information identifying a device type of the network device; and
the management controller is to determine the configuration information for the network device based on the device type identified by the discovery packet.

19. The information handling system of claim 15, wherein the management controller is to interface with a user to obtain the configuration information for the network device subsequent to receiving the discovery packet and to transmit the response packet with the configuration information responsive to obtaining the configuration information from the user.

20. The information handling system of claim 15, wherein:
the data link layer comprises an Ethernet network; and
the discovery packet and the response packet comprise Ethernet packets.
